(19) United States
(12) Patent Application Publication
(10) Pub. No.: US 2008/0147782 A1
(43) Pub. Date: Jun. 19, 2008

(54) SYSTEM AND METHOD FOR MANAGING FIXTURE CALIBRATION REPORT

(75) Inventors: LEI LI, Shenzhen (CN); PING CHEN, Shenzhen (CN); LIANG-LIANG SONG, Shenzhen (CN); LI-SHA CHEN, Shenzhen (CN); HAN-YING CHEN, Shenzhen (CN); CHUN-YING WANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/832,617

(22) Filed: Aug. 1, 2007

(30) Foreign Application Priority Data
Dec. 13, 2006 (CN) 200610157605.7

(51) Int. Cl. G06F 15/16; G06F 17/30; G06F 7/00

(52) U.S. Cl. 709/203; 707/1; 707/E17.01; 707/E17.044

(57) ABSTRACT

A system (100) for managing fixture calibration report includes a database (40) and a server (30). The database stores basic information reports and measurement reports of fixtures. The server is connected to the database and includes a calibration report generating module (301) configured to acquire relational data from the measurement reports, calculate and estimate the relational data acquired from the measurement report in order to generate a calibration report for each fixture, and an information transfer module (307) configured to obtain an electronic information account from the basic information reports. The calibration report generating module (301) is further configured for sending the calibration reports to the obtained electronic information account. A method for managing fixture calibration reports is also provided.

### BACKGROUND

1. Technical Field

The present invention relates to systems and methods for managing reports and, particularly, to a system and a method for managing calibration reports of fixtures.

2. Description of the Related Art

In manufacturing corporations, a large number of fixtures are, typically, widely used. These fixtures require regular calibration for accuracy. Calibration reports in a special format need to be created in each calibrating process to appropriately record calibration data of the fixtures.

During the process of generating a fixture calibration report, design criteria and measured values of controlled features, such as length, width, diameter, and other features, that determine the accuracy of the fixture are recorded. Relational data, such as differences between design criteria and measured value of each controlled feature, are then calculated according to these parameters and recorded. Results of whether the controlled fixtures meet the design criteria or not are then estimated and recorded. Finally, a data set (for example, an e-mail, a fax, or an instant message) including the fixture calibration report has, typically, been manually created and then transmitted to a director for approval. Generally, the aforesaid information has to be inputted manually into a computer to be recorded and processed to create a fixture calibration report. Such a manual procedure is both time consuming and highly subject to human error.

What is needed, therefore, is an improved system and an improved method for managing fixture calibration reports to overcome the above-described shortcomings.

### SUMMARY

In one aspect, a present system for managing fixture calibration report includes a database and a server. The database stores basic information reports and measurement reports of fixtures. The server is connected to the database and includes a calibration report generating module and an information transfer module. The calibration report generating module is configured for acquiring relational data from the measurement reports and calculating and/or estimating the relational data acquired from the measurement report in order to generate a calibration report for each fixture. The information transfer module is configured for obtaining an electronic information account from the basic information reports and for sending the calibration report to the obtained electronic information account.

In another aspect, a method for managing a fixture calibration report of at least one calibrated fixture includes the following steps:

providing a system for managing fixture calibration report, the system including a
database configured for storing basic information reports and measurement reports regarding each of the calibrated fixtures;
examining the measurement reports stored in the database and acquiring relational data from the measurement reports;
at least one of calculating and estimating the acquired relational data and creating a calibration report for each fixture; and
capturing an electronic information account from the basic information report and sending the calibration reports to the electronic information account.

Other advantages and novel features will become more apparent from the following detailed description when taken in conjunction with the accompanying drawings.

### BRIEF DESCRIPTION OF THE DRAWINGS

Many aspects of the present system and method for managing fixture calibration reports can be better understood with reference to the following drawings. The components in the drawings are not necessarily drawn to scale, the emphasis instead being placed upon clearly illustrating the principles of the system and method for managing fixture calibration reports. Moreover, in the drawings, like reference numerals designate corresponding parts throughout the several views.

FIG. 1 is a schematic view of a system for managing fixture calibration reports, according to a present embodiment; and

FIG. 2 is a schematic diagram of a server of the system of FIG. 1.

### DETAILED DESCRIPTION OF THE PREFERRED EMBODIMENT

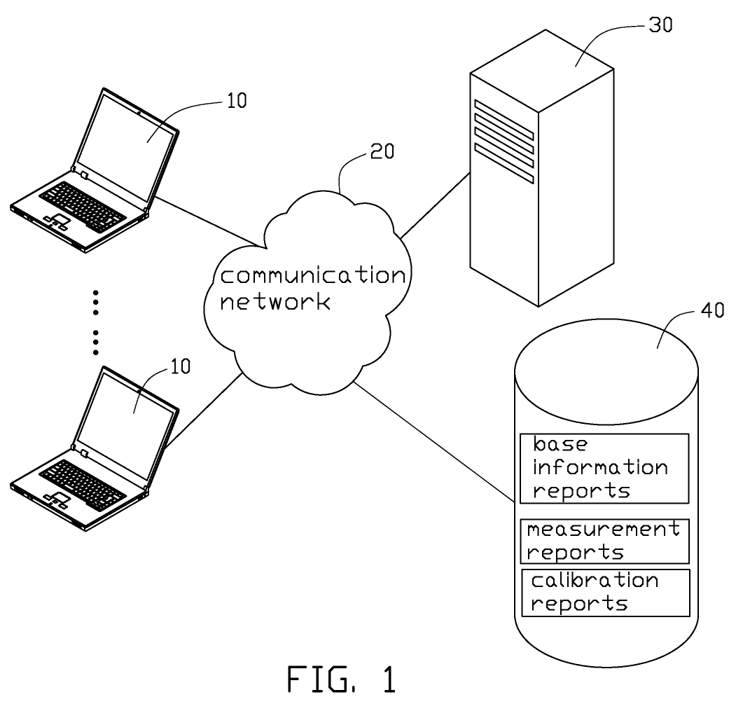

Referring now to the drawings in detail, FIG. 1 schematically shows a system 100 for managing fixture calibration reports, in accordance with a present embodiment. The system 100 includes at least one client terminal 10, a plurality of communication networks 20, a server 30, and a database 40.

The client terminal 10 is configured (i.e., structured and arranged) to interact with users. The client terminal 10 can be, for example, a personal computer (PC) (as shown in FIG. 1), a palm computer, a laptop, a mobile phone, or a personal digital assistant (PDA). Each client terminal 10 stores and runs an information transfer system. The information transfer system is configured (i.e., structured and arranged) for receiving calibration reports generated by the server 30. The information transfer system can be a web mail system, such as Lotus Notes® (owned by Lotus Development Corporation having a principle place of business at 55 Cambridge Parkway Cambridge, Mass. 02142, USA; and IBM Corporation having a principle place of business at New Orchard Road, Armonk, N.Y. 10504, USA), a facsimile machine, or an instant messaging system, such as Windows Live® Messenger (also called MSN messenger, owed by Microsoft Corporation having a principle place of business at 1 Microsoft Way Redmond, Wash. 98052, USA).

The communication network 20 can be, for example, a local area network (LAN), a wide area network (WAN), an intranet, an internet, a global system for mobile communication (GSM) network, a code division multiple access (CDMA) network, and so on, and can couple each client terminal 10 to the server 30 and, in turn, couple the server 30 to the database 40.

The database 40 stores basic information reports, measurement reports, and calibration reports of fixtures. A basic information report of a fixture records basic information, such as a name, serial number, client, last calibrating date, calibrating period, next calibrating date, status, drawings of the fixture, and/or name of the calibrating operator; and electronic information account, such as an e-mail address, a mobile phone text messaging service account, or an instant messaging (IM) account, of the director and/or others to whom the calibration report is submitted for approval and/or viewing. A measurement report of a fixture records design criteria of controlled features and measured value of corresponding controlled features of the fixture. The controlled features are parameters determining the accuracy of the fixture, and such features can be, for example, length, width, height, and/or diameter of the fixture. The design criteria of the controlled feature include at least one standard dimension of the feature and the allowable tolerances of the corresponding feature(s). The measured values are the real/actual dimensions of each controlled feature. The measurement reports includes unchecked measurement reports, which are pending for use as data resources to generate a calibration report, and checked measurement reports, which have been used as data resources to generate a calibration report. A calibration report records design criteria of controlled features and measured data of the controlled features of the fixture. In addition, the calibration report further includes differences between the design criteria and measured values of the features and provides a record of results as to whether the controlled features meet the design criteria or not. Date/time for next calibration is, beneficially, also recorded in a calibration report. The calibration reports can, rather suitably, be divided into two types, approved calibration reports and pending calibration reports, which are waiting for director approval.

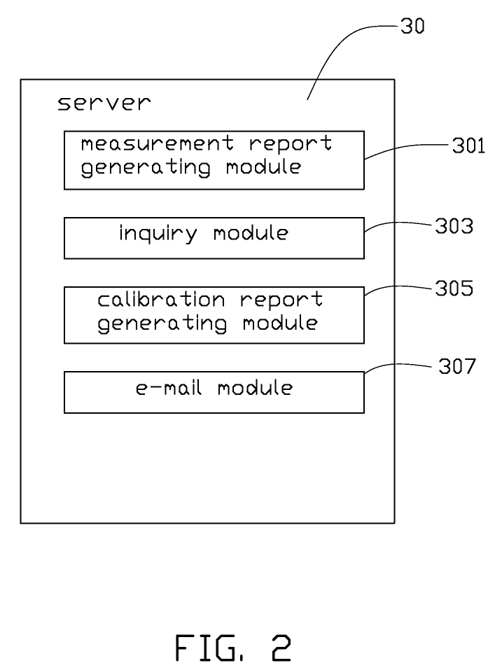

Referring to FIG. 2, the server 30, opportunely, includes a measurement report generating module 301, an inquiry module 303, a calibration report generating module 305, and an information transfer module 307.

The measurement report generating module 301 captures relational data, such as design criteria and measured values of controlled features of a fixture, and generates a measurement report for each fixture. It is to also be understood that separate reports for a number of fixtures could be consolidated into a single composite report, and such a composite report, by effectively containing a plurality of individual reports, is considered within the scope of operation of the measurement report generating module 301. The measurement report generating module 301 can, for example, acquire design criteria of a fixture from an electronic design drawing, such as a computer aided design (CAD) drawing, and/or from an original specifications print-out for a given fixture. The measurement report generating module 301 further receives measured values of the fixture from measurement equipment. The measurement equipment, such as a linear gage (e.g., calipers) or a dial indicator, can be electronically connected to the server 30 and can take measurements of the controlled features of the fixture and transmit the measured values of the controlled features to the server 30. Thus, the measurement report generating module 301 can generate a measurement report, based on the acquired relational data of the fixture. The measurement report is stored in an appointed folder in the database 40.

The inquiry module 303 examines measurement reports and calibration reports stored in the database 40 and can find, for example, unchecked measurement reports and/or pending calibration reports.

The calibration report module 305 can generate calibration reports by receiving relational data from measurement reports stored in database 40, calculating the differences between the design criteria and measured values of the controlled features, and estimating whether each controlled feature meets the design criteria or not. Such an estimation can be achieved by comparing each difference between the standard dimension of a controlled feature and the corresponding measured value with the corresponding allowable tolerance. If a difference is not greater than a corresponding allowable tolerance, the corresponding feature meets the design criteria; and, otherwise, the corresponding feature does not meet the design criteria.

The information transfer module 307 can generate a message including the basic information report and calibration report as content or as an attachment, obtain the electronic information account of a director from the basic information report, and transmit the message to the obtained electronic information account. It is to be understood that the electronic information account of the director can also be keyed in by a user or by use of another data entry means. It is to be further understood that the message generated can potentially, e.g., be displayed on a viewing screen and/or sent to a printer.

A method for managing fixture calibration report includes the following steps:

providing a system 100 for managing fixture calibration reports, wherein basic information reports, measurement reports and calibration reports of the calibrated fixtures are stored in the database 40 of the system 100;
using the inquiry module 303 to examine the measurement reports and calibration reports stored in the database 40 and to find the unchecked measurement reports and pending calibration reports;
using the calibration report generating module 305 to examine each unchecked measurement report, to acquire designed criteria and measured value of controlled features of each fixture, to calculate differences between the designed criteria and measured value of each controlled feature, and to estimate whether each controlled feature meets the design criteria or not by comparing each calculated difference with a corresponding allowable tolerance, wherein if a difference is in the range of the corresponding allowable tolerance, the corresponding feature meets the design criteria, and, otherwise, the corresponding feature does not meet the design criteria; using the calibration report generating module 305 to thereby create a calibration report for each fixture; and
employing the information transfer module 307 to generate a message including the calibration report as, e.g., e-mail content or as an attachment, to obtain an electronic information account of a corresponding director from a basic information report of the corresponding fixture, and to send the message to the electronic information account of the director for approval via the communication network 20.

Understandably, the system 100 and the aforementioned method for managing fixture calibration report can create and transmit fixture calibration report automatically and prevent mistakes caused by manually inputting data. In this way, accuracy of the calibration report is improved, and management of the fixture calibration report is time saving.

It is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A system for managing fixture calibration report comprising:
a database configured for storing basic information reports and measurement reports of fixtures, the basic information reports including fixture design criteria for each fixture; and
a server connected to the database and comprising a calibration report generating module configured for acquiring relational data from the measurement reports and for calculating and estimating, based upon the relational data acquired from the measurement report, whether each controlled feature meets the fixture design criteria thereof or not, in order to generate a calibration report for each fixture, the server further comprising an information transfer module configured for obtaining an electronic information account from the basic information reports and for sending the calibration reports to the obtained electronic information account.

2. The system as claimed in claim 1, wherein the relational data acquired from the measurement report comprises design criteria and a respective measured value of each controlled feature of the fixture, and the calibration report generating module calculates respective differences between the design criteria and a given respective measured value of each controlled feature and then estimates whether each controlled feature meets the design criteria or not.

3. The system as claimed in claim 2, wherein the server further comprises a measurement report generating module configured for acquiring design criteria of controlled features from an electronic drawing of the fixture, receiving the respective measured value of each controlled feature from a measurement device connected to the server, creating a measurement report based on the acquired data, and storing the measurement report in the database.

4. The system as claimed in claim 1, wherein the server further comprises an inquiry module configured for finding any unchecked measurement reports and any pending calibration reports.

5. The system as claimed in claim 4, wherein the calibration report generating module generates a calibration report of a corresponding unchecked measurement report found by the inquiry module.

6. The system as claimed in claim 1, further comprising at least one client computer connected to the server, and each client computer has an information transfer system for receiving calibration reports transmitted by the server.

7. The system as claimed in claim 6, further comprising a communication network coupling the at least one client computer to the server and coupling the server to the database.

8. A method for managing a fixture calibration report, the method comprising the following steps:
providing a system for managing a fixture calibration report, wherein basic information reports and measurement reports of the calibrated fixtures are stored in a database of the system;
examining the measurement reports stored in the database and acquiring relational data from the measurement reports;
calculating and estimating whether each controlled feature meets the fixture design criteria thereof or not, based on the acquired relational data, and creating a calibration report based upon results from the step of calculating and estimating; and
capturing an electronic information account from the basic information report, and sending the calibration reports to the electronic information account.

9. The method as claimed in claim 8, wherein, before the step of examining the measurement reports occurs, there is a step for creating a measurement report by acquiring relational data from electronic drawings of the given fixture and recording a measurement device used to measure the fixture.

10. The method as claimed in claim 8, wherein the step of acquiring relational data comprises acquiring design criteria and respective measured values of controlled features of the fixture.

11. The method as claimed in claim 10, wherein the step of calculating the acquired relational data comprises calculating differences between design criteria and a corresponding measured value of each controlled feature.

12. The method as claimed in claim 11, wherein the step of estimating the acquired relational data comprises comparing each calculated difference with a corresponding allowable tolerance of the controlled feature to estimate whether each controlled feature meets the design criteria.
